(19) United States
(12) Patent Application Publication
(10) Pub. No.: US 2016/0258804 A1
(43) Pub. Date: Sep. 8, 2016

(54) System and Method for Monitoring Liquid levels and Providing Alert to Rising Liquid Levels

(71) Applicant: Patrick Desautels, Lac Labiche (CA)

(72) Inventor: Patrick Desautels, Lac Labiche (CA)

(21) Appl. No.: 14/637,144

(22) Filed: Mar. 3, 2015

(51) Int. Cl. G01F 23/32; G08B 21/18

(52) U.S. Cl. CPC G01F 23/32; G08B 21/182

(57) ABSTRACT

The present invention is a system for alerting a user to a possible liquid overflow including a base, balance beam arm, pivotally attached to the base, a float ball, a beam-to-ball connector, an alarm actuator, and an alarm.

### BACKGROUND OF THE INVENTION

It is often desirable to monitor liquid levels in particular containers. With the monitoring of liquid levels comes the problem of alerting persons to possible liquid overflow. While many systems have been developed to alert of overflow once overflow has begun, there seems to be a short of systems that alert when an overflow is about to occur. The present invention addresses this difficulty.

### SUMMARY OF THE INVENTION

In one embodiment, the high water alarm of the present invention would monitor the rise of water in a tub or sink while the occupant of the residence continue or is distracted by other task in the same residence. The alarm would prevent flooding a tub, a sink, or any kind of container to be filled by fluid.

In one embodiment, the float ball is configured to change color based on temperature.

In one embodiment, the present invention includes, a system for alerting a user to a possible liquid overflow, said system comprising: a base; a balance beam arm, whereby said balance beam arm is pivotally attached to said base; a float ball; a beam-to-ball connector; an alarm actuator; and an alarm. The float ball is placed on the upper liquid surface of a container.

In one embodiment, the ball to beam connector is adjustable. This allows a user to measure and determine a critical height or critical position. The configuration of critical position is that height at which, when the liquid rises, float ball, is elevated vertically, the balance beam arm pivots and the movement into the critical position actuates the actuator.

The system alarm is visual, audio, a wirelessly transmitted alert, or combinations thereof. In one embodiment, the system is configured with electronic communications configured to send an SMS, MMS, e-mail, or other alert to a mobile computing device such as a cell phone, smart phone, tablet computer and the like, alerting a person receiving the transmission that the critical position has been reached and warning of a possible overflow. In one embodiment, the system includes an adjustable bean to ball connector.

It is contemplated that the present invention provides green advantages that can help the end user. For example, when the invention is set at a desired level, it would eliminate the use of excessive water usage. This would be highly advantageous to end consumers in drought sensitive areas, or individuals trying to conserve finance's on their utility bills.

Also contemplated in the present invention is a method for alerting an elevated liquid level, said method comprising the steps of:
providing a system according to the invention described herein;
placing said system in a position such that said float ball is positioned on a liquid surface in a container;
measuring a critical height relative to the upper edge of said container;
configuring a distance of said beam to ball connector in which said float ball at said critical height, actuates the actuator;
placing the float ball on the liquid surface.

The figures provided are demonstrative of embodiments and are not intended to limit the present invention.

### BRIEF DESCRIPTION OF THE SEVERAL VIEWS OF THE DRAWING

FIG. 1 is a general isometric view of the components of one embodiment of the present invention.

FIG. 2 is a side view of the present invention in the low-level alert position.

FIG. 3 is a side view of the present invention in the high-level alert position.

FIG. 4A is one embodiment of a ballast used according to one embodiment of the present invention.

FIG. 4B is one embodiment of a ballast used according to one embodiment of the present invention.

FIG. 4C is one embodiment of a ballast used according to one embodiment of the present invention.

FIG. 4D is one embodiment of a ballast used according to one embodiment of the present invention.

FIG. 5 is a side partial cross-section view of positioning of the ball according to one embodiment of the present invention.

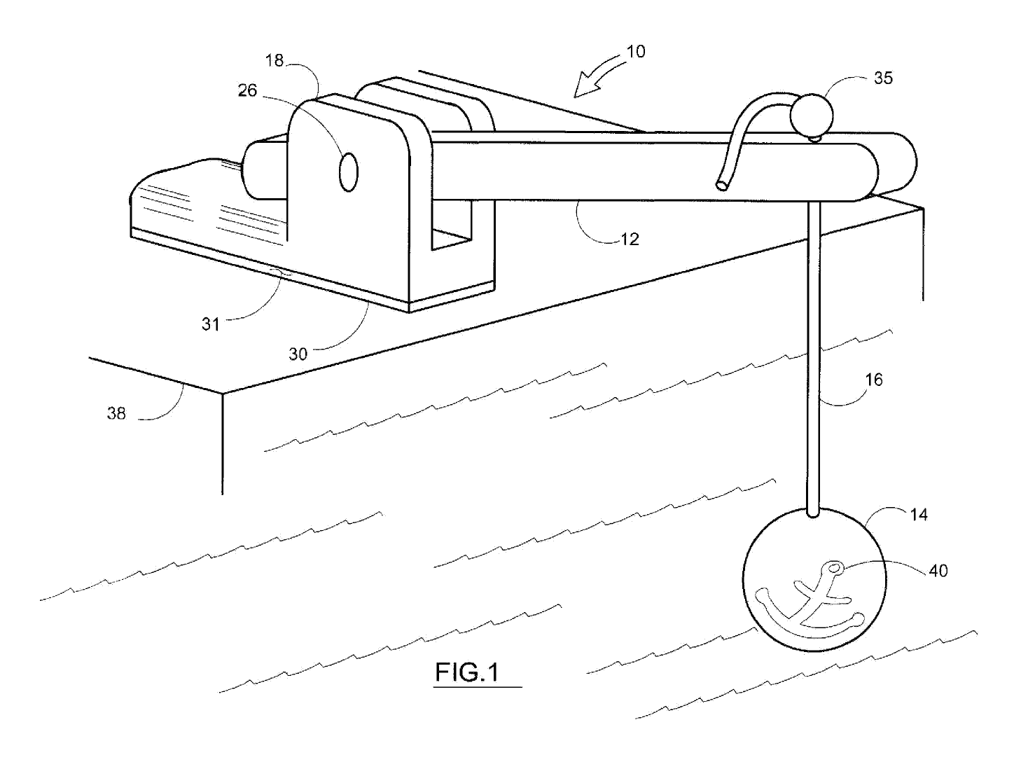

### DETAILED DESCRIPTION OF THE PREFERRED EMBODIMENT

As generally understood, the present invention relates to a mechanism for alerting to elevated water levels. System 10 includes a balance beam arm 12 that supports a beam-to-ball connector 16. In one embodiment, beam-to-ball connector 16 is positioned with a positioning adjusting ball 35. Beam-to-ball connector 16 attaches to float ball 14.

In one embodiment, float ball 14 has a customizable ballast 40 inside float ball 14. In one embodiment, float ball 14 is transparent, translucent, or combinations thereof.

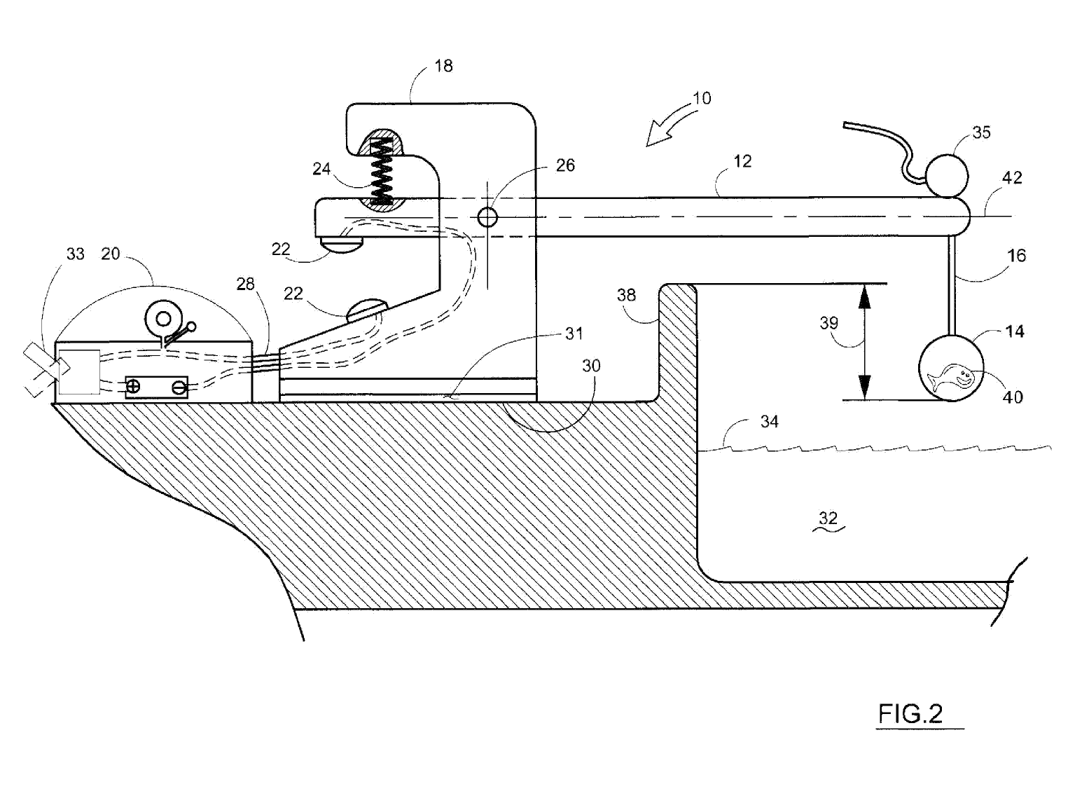

Beam 12 connects to mechanism body 18 at beam pivot pin 26. Apparatus 10 further includes an anti-skid plate 31 on the underside of apparatus 10, whereby anti-skid plate 31 allows apparatus 10 to rest on mounting surface 30. Apparatus 10 is placed next to a liquid container 38. In one embodiment, as demonstrated in FIG. 2, a liquid 32 has an upper surface or level 34. Upper level surface 34 is at or below float ball 14.

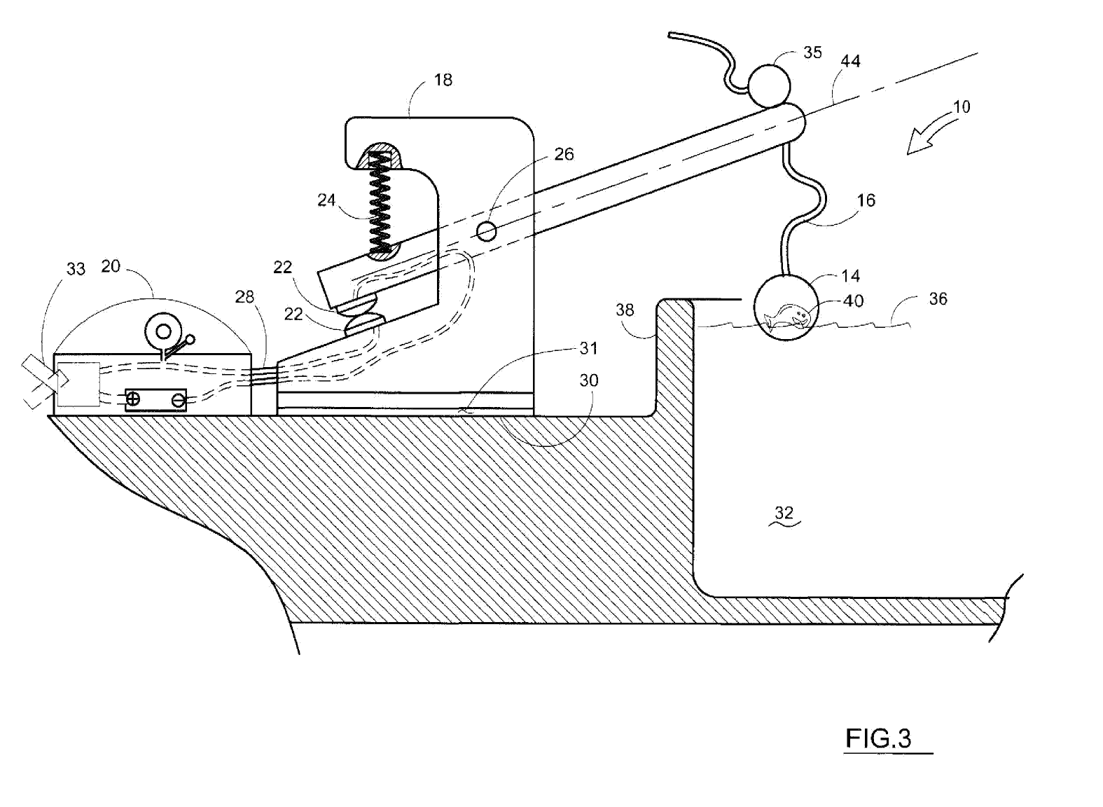

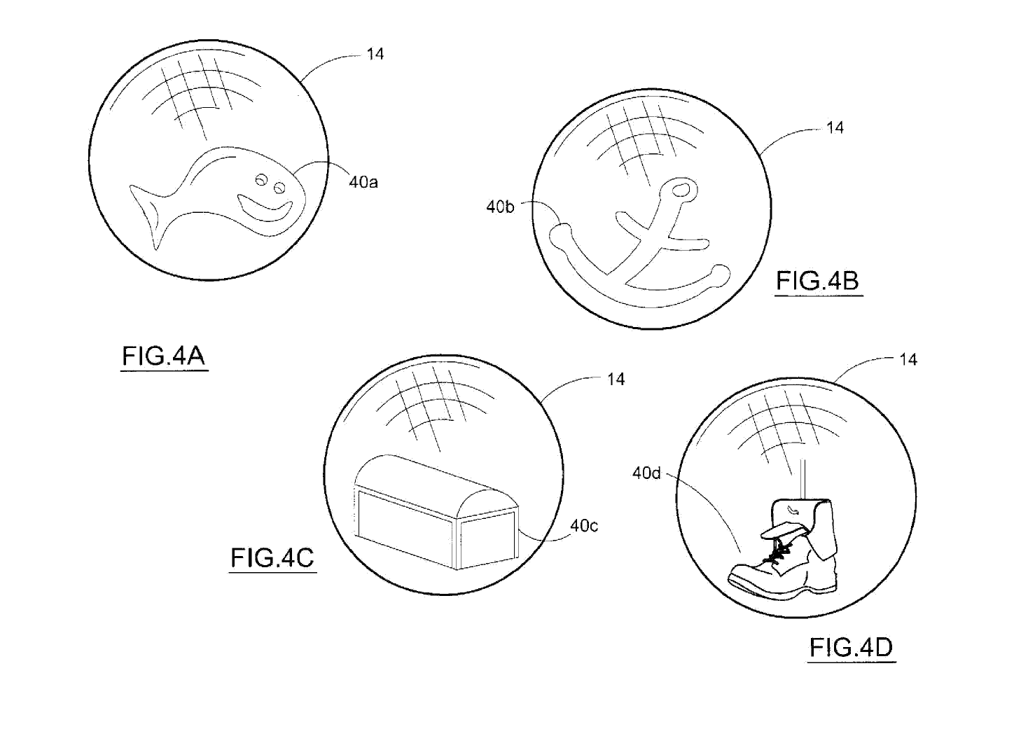

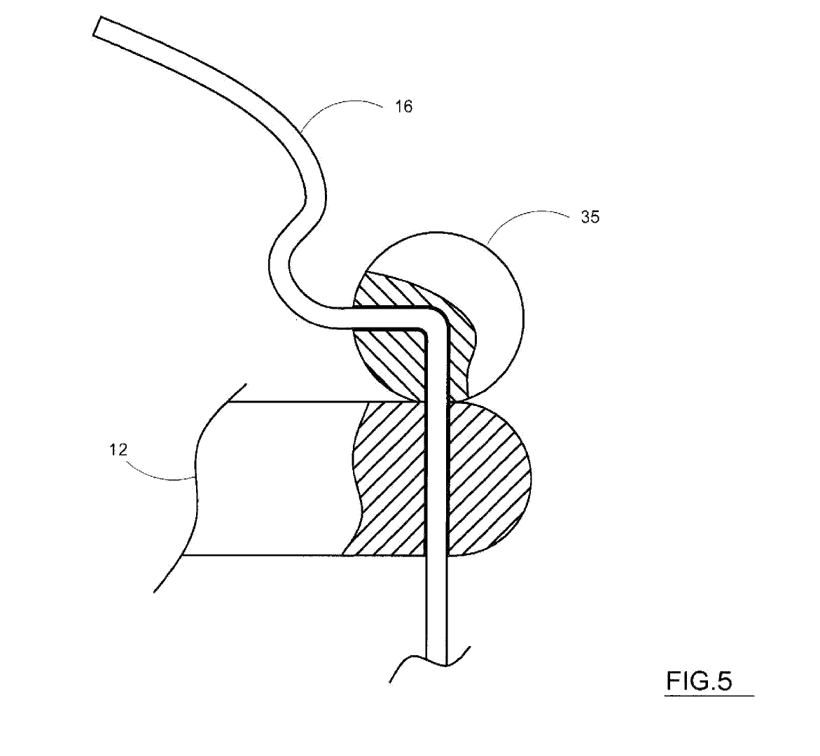

Distance 39 represents the resting distance of system 10 with an overflow level of liquid container 38. When liquid level 36 approaches an overflow level at the top of container 38, as demonstrated in FIG. 3, balance arm 12 is pivoted upward. Balance spring 24 urges the proximal end of balance arm 12 downward in response to a change in force no longer imparted by float ball 14. When balance beam 12 reaches its preset limit, electrodes 22 contact each other. Electrodes 22 are connected with wires 28 to alarm mechanism 20. Alarm mechanism 20 is actuated and an alert is started. The alert can be any of a visual, audio, electrical, or combinations thereof alert that is configured to allow a user to know the water level 36 is reaching an overflow point.

In use, the present invention is positioned next to a liquid container that has a desired liquid height. Containers include, but are not limited to, bathtub, sink, pool, or any other liquid container with a liquid height that is desired to stay within the periphery of the container. When water level 36 rises, float ball 14 rises with the level of water level height 36. As float ball 14 rises, there is no longer a downward pressure imparted on balance beam arm 12. Without the downward pressure exerted on the distal end of balance beam arm 12, spring 24 urges balance beam arm 12 downward such that an angular offset angle 44 is imparted by pivotal rotation of balance beam arm 12 about pivot pin 26.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A system for alerting a user to a possible liquid overflow, said system comprising: a base; a balance beam arm, whereby said balance beam arm is pivotally attached to said base; a float ball; a beam-to-ball connector; an alarm actuator; and an alarm.

2. The system of claim 1 wherein said float ball is placed on the upper liquid surface of a container.

3. The system of claim 1 including configuration of critical position for said float ball, whereby said critical position actuates said actuator.

4. The system of claim 1 wherein said wherein said alarm is visual, audio, a wirelessly transmitted alert, or combinations thereof.

5. The system of claim 1 including an adjustable bean to ball connector.

6. A method for alerting an elevated liquid level, said method comprising the steps of:
providing a system according to claim 1;
placing said system in a position such that said float ball is positioned on a liquid surface in a container;
measuring a critical height relative to the upper edge of said container;
configuring a distance of said beam to ball connector in which said float ball at said critical height, actuates the actuator;
placing the float ball on the liquid surface.
